(19) United States
(12) Patent Application Publication
(10) Pub. No.: US 2006/0229812 A1
(43) Pub. Date: Oct. 12, 2006

(54) Device radio-based danger warning

(75) Inventors: Lutz Eckstein, Stuttgart (DE); Volker Entenmann, Affalterbach (DE); Markus Hess, Baltmannsweiler (DE); Uwe Petersen, Steinenbronn (DE); Werner Reichelt, Fellbach (DE); Thomas Unselt, Stuttgart (DE); Richard Zimmer, Fellbach (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER, STUTTGART (DE)

(21) Appl. No.: 10/526,551

(22) PCT Filed: Aug. 22, 2003
(86) PCT No.: PCT/EP03/09330

§ 371 Date: May 11, 2006

(30) Foreign Application Priority Data
Sep. 3, 2002 (DE) 102 41 134.4

(51) Int. Cl. G06G 7/78

(52) U.S. Cl. 701/300

(57) ABSTRACT

In a radio-based device for issuing hazard warnings to the driver of a vehicle a data receiver situated on board the vehicle receives hazard data from a data transmitter of at least one other vehicle, and evaluates the received data in a computer unit. The received data includes information about the position, speed and direction of travel of the transmitting vehicle. According to the invention, from the received data of the transmitting vehicle and from information relating to the position, speed and direction of travel data of the receiving vehicle, a relevance measure is determined in the receiving vehicle, which relates to whether the transmitting vehicle is located on a section of road lying ahead of the receiving vehicle. A chronological profile of the relevance measure is determined by repeatedly determining the relevance measure.

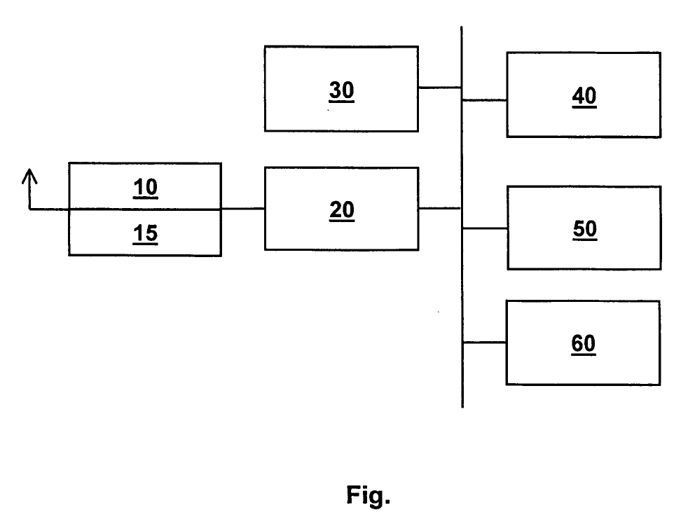

### CROSS-REFERENCE TO RELATED APPLICATIONS

This application is related to co-pending application Ser. No. ______, filed Mar. 3, 2005 and assigned to the same assignee.

### BACKGROUND AND SUMMARY OF THE INVENTION

This application claims the priority of German patent document 102 41 134.4, filed Sep. 3, 2002 (PCT International Application No. PCT/EP2003/009330, filed Aug. 22, 2003), the disclosure of which is expressly incorporated by reference herein.

The present invention relates to a device for radio-based issuance of hazard warnings to a vehicle operator.

European patent document EP 927 983 A2 discloses such a system for radio-based issuance of hazard warnings in which vehicles are equipped with data transmitters and receivers in order to exchange hazard warning data. After the data transmitter has been activated, data relating to the hazard are transmitted to other motor vehicles, together with information relating to the position, speed and direction of travel of the transmitting vehicle. In the receiving vehicle, the received data are evaluated to determine whether or not a hazard lies ahead, and if so, warning signals are conveyed to the driver.

French patent document FR 2 793 056 describes a device for issuing hazard warnings, in which the type of hazard is indicated in the vehicle. In the receiving vehicle it is determined whether it is necessary to output the warning to other vehicles.

International patent document WO 01/61668 A1 discloses a hazard warning device, in which a warning zone is generated in the transmitting vehicle and is output together with the hazard warning. In the transmitting vehicle, the position of the vehicle and the type of road on which the vehicle is located are determined using a navigation system. The difference between the speed of the transmitting vehicle and the typical or maximum speed of other vehicles on the given type of road is included in the calculation of the warning zone in the transmitting vehicle. The received hazard warning is evaluated in the receiving vehicle using a navigation system by checking whether the receiving vehicle is in the warning zone and whether the hazard warning relates to a section of road which possibly lies in front of the receiving vehicle.

The document “WARN—ein neues funkbasiertes Gefahrenwarnsystem im Kfz für mehr Sicherheit im Straβenverkehr” [WARN—a new radio-based hazard warning system in motor vehicles for providing more safety in road traffic], Brenzel, C., Hickel, F., Paβmann, C., VDI Berichte [VDI Reports] No. 1415, 1998 discloses that, together with the hazard warning, the type of hazard, the speed of the transmitting vehicle and information about the position of the transmitting vehicle can be transmitted. In the receiving vehicle, the difference in speed relative to the transmitting vehicle is determined, and information about the position of vehicles is used to determine whether the warning message has been generated by a vehicle traveling in front, by a vehicle behind, or by the oncoming traffic.

In “Wireless Vehicle to Vehicle Warning System”, Paβmann, C., Brenzel, C., Meschenmoser R., SAE Paper, 2000-01-1307, a check is made in the receiving vehicle as to whether the transmitting vehicle is located in front of or behind the receiving vehicle.

German patent document DE 199 52 392 A1 discloses a method in which warning information that is dependent on the route is made available to the driver. Digital road maps are used to detect, for example, whether the driver is approaching a curve. If so, and if the current speed of the vehicle is higher than a speed limit for the curve, the driver is first warned visually. If he or she does not react to the visual warning within a certain time, (i.e., if he or she continues to drive with undiminished speed), an additional audible warning is issued. Since the curve has a fixed position, its approach is always detected at a sufficiently large distance, and various warning stages of increasing urgency are successively triggered.

One object of the present invention is to provide an improved device for issuing warnings of hazards with improved detection of relevant hazard warnings.

This and other objects and advantages are achieved by the hazard warning system according to the invention, which generates a hazard warning that extends beyond the visual range of a hazard warning system, providing an electronic lengthening of the classic hazard warning system. A significant component of the device is a radio modem which permits the direct exchange of data between vehicles in real time and with a sufficiently large range (for example, approximately 1 km). In addition, the device may also include a locating module with which the position of the vehicle can be determined by locating means. The locating module may be a component of a navigation system, or it may be connected to a navigation system, in which case the position of the vehicle can be determined with even greater accuracy because the measured position of the vehicle can be represented on the digital map which is present in the navigation system by map matching. As a result, errors in the position determination can be compensated by the locating module.

The data which are received by the transmitting vehicle comprises here information on the position of the transmitting vehicle, determined by a locating device and/or a directional course of the vehicle. A directional course of the vehicle is formed from the direction of travel and speed of the vehicle at various times. The received information relating to the position optionally also includes additional information about earlier positions of the transmitting vehicle. The earlier positions of the vehicle form a position chain of the vehicle which is composed of a sequence of points at which information relating to the position of the vehicle is present. In this context, the position chain can be a directional course and/or a sequence of positions which are determined by a locating system or navigation system.

A relevance measure, which is determined from the received data of the transmitting vehicle and the position, speed and direction of travel data of the receiving vehicle, expresses the probability that the transmitting vehicle is located on the section of road lying in front of (that is, downstream of) the receiver. The receiving vehicle advantageously has information about the route, which is used to estimate in advance the future route of the receiving vehicle. The relevance measure, which expresses the probability that the transmitting vehicle is located on the predicted future route of the receiving vehicle, is advantageously determined from the data received from the transmitting vehicle, together with the predicted future route of the receiving vehicle. Determining the chronological profile of the relevance measure makes possible more reliable detection of relevant locations of hazards.

In one advantageous embodiment of the invention, incorrect warnings are detected based on the chronological profile of the relevance measure. Information is advantageously output as a function of the relevance measure determined. (Thus, for example, information whose relevance measure is too low is not output.)

In one advantageous embodiment of the invention, the output of information to the driver is terminated as soon as a warning is determined to be incorrect. In this context, it is advantageous if, as soon as the output of information is terminated owing to an incorrect warning, the driver is explicitly informed, by means of a directly following information output, that the previously reported hazard is no longer relevant to him.

The invention helps to prevent, for example, mass pileups of vehicles such as can occur, for example, on freeways, frequently due to poor visibility conditions (for example fog), sections of road with poor visibility (for example, before a curve which cannot be seen into satisfactorily) or due to traffic disruption (for example end of congestion or roadworks). The invention makes it possible for the drivers of following vehicles to detect hazards ahead and to brake their vehicle in time to avoid a collision. In one embodiment the vehicle can be braked automatically, by an intervention in the vehicle control systems.

In another embodiment of the invention, the hazard warning device comprises a data transmitter which is triggered, for example, by the hazard warning system of the vehicle. If the hazard warning system of a vehicle is triggered in this embodiment, a corresponding radio message is emitted to all the vehicles in the vicinity of the transmitting vehicle. The transmitted data of each transmitter includes its current speed and its position chain. It is also possible for the transmitter to transmit its identification number and/or a type of hazard.

Other objects, advantages and novel features of the present invention will become apparent from the following detailed description of the invention when considered in conjunction with the accompanying drawings.

### BRIEF DESCRIPTION OF THE DRAWINGS

The single figure of the drawing is a block diagram of a device for radio-based issuing of warnings of hazards, according to the invention.

### DETAILED DESCRIPTION OF THE DRAWINGS

As shown in the figure, the radio based hazard warning device according to the invention comprises a data receiver unit 10, data transmitter unit 15 and a computer unit 20. The device is preferably connected to a navigation system 30, an output unit 40, an activation device 50 and a sensor unit 60 via a vehicle bus system. The sensor unit may comprise a plurality of different sensors, such as a crash sensor, a speed sensor etc. The activation device 50 may be, for example, the hazard warning system of the vehicle.

The position information which is output by a transmitting vehicle advantageously includes a directional course of the vehicle, formed from the direction of travel and speed of the vehicle at various times. Alternatively (or in addition), information about the position is generated by a navigation system 30, advantageously using a locating device, for example GPS. The type of road and the direction of travel can also be determined using a navigation system 30. An example of the determination of the position, type of road and direction of travel by means of a navigation system 30 is described in International patent document WO 01/61668 A1, the disclosure of which is incorporated by reference, as fully as if set forth in its entirety herein. An example of the determination of the position, type of road and direction of travel using directional courses of vehicles is found in European patent document EP 0 927 983 A2, the disclosure of which is also incorporated by reference.

The position chain of a vehicle is composed of a sequence of points for which information relating to the position of the vehicle is present. The position chain may be a directional course and/or a sequence of positions which are determined by means of a locating system or navigation system 30. The position chain describes the geometry of the route covered by the transmitting vehicle (the “transmitter”) in the recent past. By comparing its own position chain with the position chain of the transmitter, the receiving vehicle (the “receiver”) can check whether the routes covered theretofore by both vehicles are identical, and whether the transmitter is ahead of the receiver (that is, downstream of it), or behind it (upstream of it). The result of this comparison is expressed by a relevance measure. For example, on freeways it is possible to detect whether the transmitter is located on the same roadway ahead of the receiver or on the opposite roadway. If the transmitter is located ahead of the receiver on the same roadway, the relevance measure is large and the driver of the receiver must be warned before the signaled hazard. If the transmitter is located behind the receiver or on the opposite roadway, the relevance measure is small and the received hazard message has no significance for the driver of the receiver.

A further advantage of the device described here is the ability to detect incorrect warnings (that is, a warning regarding a hazard which is not located on the driver's future route). There are certain situations in which an incorrect warning is unavoidable. If for example, the transmitter is located just beyond a fork in the roadway (for example, on the left hand branch), the driver of the receiver must be warned of the signaled hazard even if at the time when the warning is triggered it is not yet known whether the receiver will travel on the left-hand or right-hand branch of the fork. Irrespective of the future decision to make a turn, the relevance measure of the transmitter is sufficiently large to trigger a warning.

However, after the fork is reached the further course of the relevance measure depends on whether the receiver travels along the left-hand or right-hand branch of the fork. In the first case, the position chains of the transmitter and receiver continue to correspond satisfactorily, the relevance measure remains high and the warning is maintained. In the second case, the position chains of the transmitter and receiver diverge and the relevance measure drops. If it drops below a given threshold value, it can be assumed that the transmitter and receiver are located on different routes, and the warning has been incorrectly triggered. An incorrect message is therefore detected by the trailing edge of the relevance measure. In this case, not only is the warning terminated, but the driver is also explicitly informed that the previously signaled hazard is no longer relevant to him. This prevents the driver's losing confidence in the radio warning system due to incorrect warnings which are unavoidable under certain circumstances. It also prevents the driver's being surprised by the apparently inexplicable disappearance of the warning.

The hazard warning can also be refined by routes information which can be obtained, for example, from a digital road map. On the one hand, it is possible to use the route information to predict the future route of the transmitter, at least as far as the next intersection point. As a result, the position chain of the transmitter can be lengthened and the reliability of the relevance measure, which depends on the length of overlap between the position chains of the transmitter and receiver, can be increased.

Furthermore, by previewing the route, it is possible to determine the distance between the transmitter and receiver more accurately because the precise geometry of the part of the route lying between the two vehicles is known. Likewise, incorrect warnings can in certain situations be avoided by means of the route information. If, for example, it is detected that a transmitter is located after a fork, then only warning levels of high urgency can be permitted, ensuring that the distance threshold for the triggering of the warning is located beyond the fork so that it is possible to wait to see whether after the fork the receiver will travel on the same branch as the transmitter or select the other alternative route.

Advantageously, the driver is warned as long as radio messages are received and the transmitter is located ahead of the receiver. However, it is necessary to take into account the fact that temporary disruption of the communication link may occur as a result of external influences. For this reason, if no further radio messages are received, this is initially interpreted as a temporary interruption in the communication link and not as a deactivation of the transmitter. The warning is furthermore maintained and the relative movement of the receiver with respect to the transmitter is continued on the assumption that the transmitter continues moving with its last-known speed. The warning is terminated only if no further radio messages are received for a sufficiently long time, but at the earliest after a minimum warning time, which ensures that the driver can also perceive the indicated warning.

A warning is also terminated if the driver of the receiver indicates, by switching on his own hazard warning system, that he has detected the signaled hazard. The switching on process of the hazard warning system, and not the state “hazard warning lights on” is advantageously used as a criterion for the termination of the warning since otherwise the driver would not receive any warning if he were to approach a transmitter with his hazard warning system already switched on (because, for example, he is towing another vehicle). The possibility of switching on his own hazard warning system is an advantageous way for the driver to acknowledge a warning, and thus terminate it manually. Restriction to this type of acknowledgement keeps the system simple; however, more wide-ranging operating control actions are possible.

A warning is also terminated automatically if the approach speed of the receiver to the transmitter or the absolute speed of the receiver become very low. This prevents, for example, a display in the vehicle being blocked for an unnecessarily long time.

Scenarios are possible, for example when a vehicle is approaching the end of a traffic jam, in which a plurality of transmitters emit radio messages simultaneously.

With the system described here, the radio messages of any desired number of transmitters can be processed in parallel. Successive radio messages from the same transmitter are recognized on the basis of their common identification number. At first, individual checking is carried out for each transmitter to determine which relevance measure is to be assigned to it.

In order to determine the chronological profile of the relevance measure for each of the transmitting vehicles, the relevance measure is determined for each transmitting vehicle at time intervals. By means of the chronological profile it is then possible, for example, to determine which messages are incorrect messages.

In terms of the types of hazard a distinction is made between a general hazard, a virtual warning triangle, an accident and roadworks. The general hazard is transmitted if the driver has manually triggered the hazard warning system and the engine of the vehicle is running (for example when approaching the end of a traffic jam). The virtual warning triangle type of hazard is transmitted if the driver has triggered the hazard warning system manually and the engine of the vehicle is off (for example because the vehicle has broken down). The accident type of hazard is transmitted if the hazard warning system has been triggered automatically by the crash sensor of the vehicle. And finally, the roadworks type of hazard is not transmitted by vehicles but rather by beacons which mark the start of roadworks.

The driver can be informed visually and/or audibly about the hazard lying ahead. The visual warning is implemented by a display which is mounted in the vehicle. Such a display is preferably integrated in the combination instrument and is thus located in the primary field of vision of the driver. At this location, the attention of the driver can advantageously be drawn to the hazard warning by means of a visual output. The visual warnings can also be supplemented by audible signals or voice outputs in order to ensure reliable perception of the warning even if the driver's gaze is averted from the combination instrument (because he is, for example, operating the radio or some other operating device mounted in the center console or is concentrating completely on observing the surrounding traffic situation).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-12. (canceled)

13. A radio-based device for issuing hazard warning information to a driver of a receiving vehicle having a data receiver which receives hazard data from a data transmitter of at least one other vehicle, and evaluates the received data; wherein:
received data includes information regarding position, speed and direction of travel of the at least one other vehicle;
based on (i) the received data from the at least one other vehicle, (ii) information regarding position, speed and direction of travel of the receiving vehicle, a relevance measure is determined in the receiving vehicle, which relates to whether the at least one other vehicle is located on a section of road lying ahead of the receiving vehicle; and
a chronological profile of the relevance measure is determined by repeatedly determining the relevance measure.

14. The device as claimed in claim 13, wherein the chronological profile of the relevance measure is stored in the receiving vehicle.

15. The device as claimed in claim 13, wherein incorrect warnings are detected based on the chronological profile of the relevance measure.

16. The device as claimed in claim 13, wherein the received data comprise a position chain of the at least one other vehicle.

17. The device as claimed in claim 13, wherein a future route of the receiving vehicle is estimated in advance in the receiving vehicle.

18. The device as claimed in claim 17, wherein the relevance measure is determined from the received data of the at least one other vehicle and the estimated future route of the receiving vehicle.

19. The device as claimed in claim 13, wherein the hazard warning information is output as a function of the determined relevance measure.

20. The device as claimed in claim 19, wherein the information output is terminated as soon as it has been detected as an incorrect warning.

21. The device as claimed in claim 20, wherein after the information output has been terminated, the driver is informed by a further information output that a previously signaled hazard warning information is no longer applicable.

22. The device as claimed in claim 13, wherein data is received from data transmitters of a plurality of other vehicles, and is evaluated.

23. The device as claimed in claim 13, wherein the chronological profile of the relevance measure is determined in each transmitting vehicle from which data is received.

24. The device as claimed in claim 13, further comprising:
a data transmitter which, when activated, outputs data to issue warnings of hazards to other vehicles;
wherein the transmitted data comprise information about position, speed and direction of travel of the transmitting vehicle.

25. A method of issuing hazard warning information to a driver of a receiving vehicle, comprising:
a receiving on board said receiving vehicle receiving information transmitted from at least one other vehicle regarding a hazard in a vicinity of said at least one other vehicle;
said receiver also receiving from said at least one other vehicle information regarding position, speed, and direction of travel of said at least one other vehicle;
based on said position speed, and direction information from said at least one other vehicle, and on information regarding position, speed and direction of travel of the receiving vehicle, determining a relevance measure that is indicative of a likelihood that the receiving vehicle will encounter said hazard;
determining a chronological profile of the relevance measure, based on repeated relevance measure determinations; and
issuing a hazard warning to said driver as a function of said chronological profile of said relevance measure.

26. The device as claimed in claim 25, wherein a future route of the receiving vehicle is estimated in advance in the receiving vehicle.

27. The device as claimed in claim 26, wherein the relevance measure is determined from the received data of the transmitting vehicle and the estimated future route of the receiving vehicle.
